(19) United States
(12) Patent Application Publication
(10) Pub. No.: US 2004/0192315 A1
(43) Pub. Date: Sep. 30, 2004

(54) Method for dynamically assigning spreading codes

(76) Inventors: Jimmy Kwok-On Li, Little Ferry, NJ (US); Patrick Li, Mendham, NJ (US); David Albert Rossetti, Randolph, NJ (US); Stanley Vitebsky, Parsippany, NJ (US)

Correspondence Address: Lucent Technologies Inc., Docket Administrator (Room 3J-219), 101 Crawfords Corner Road, Holmdel, NJ, 07733-3030, US

(21) Appl. No.: 10/107,024

(22) Filed: Mar. 26, 2002

(51) Int. Cl. H04Q 7/20

(52) U.S. Cl. 455/447; 370/335; 455/452.1

(57) ABSTRACT

A method for assigning a number of spreading codes by a base station. The method includes comparing a number of spreading codes in use by the base station with a first threshold. Thereafter, one radio configuration is assigned by the base station if the number of spreading codes in use is less than or equal to the first threshold. Alternatively, if the number of used spreading codes is greater than the first threshold, then a ratio of spreading code usage to power usage with is compared with a second threshold. If the ratio is determined to be less than the second threshold, then a different radio configuration is assigned by the base station.

### BACKGROUND OF THE INVENTION

I. Field of the Invention

The present invention relates to communication systems, and more particularly, to spreading codes.

II. Description of the Related Art

Wireless communications systems provide wireless service to a number of wireless or mobile units situated within a geographic region. The geographic region supported by a wireless communications system is divided into spatially distinct areas commonly referred to as “cells.” Each cell, ideally, may be represented by a hexagon in a honeycomb pattern. In practice, however, each cell may have an irregular shape, depending on various factors including the topography of the terrain surrounding the cell. Moreover, each cell is further broken into two or more sectors. Each cell is commonly divided into three sectors, each having a range of 120 degrees.

A conventional cellular system comprises a number of cell sites or base stations geographically distributed to support the transmission and reception of communication signals to and from the wireless or mobile units. Each cell site handles voice communications within a cell. Moreover, the overall coverage area for the cellular system may be defined by the union of cells for all of the cell sites, where the coverage areas for nearby cell sites overlap to ensure, where possible, contiguous communication coverage within the outer boundaries of the system's coverage area.

Each base station comprises at least one radio and at least one antenna for communicating with the wireless units in that cell. Moreover, each base station also comprises transmission equipment for communicating with a Mobile Switching Center (MSC). A mobile switching center is responsible for, among other things, establishing and maintaining calls between the wireless units, between a wireless unit and a wireline unit through a public switched telephone network (PSTN), as well as between a wireless unit and a packet data network (PDN), such as the Internet. A base station controller (BSC) administers the radio resources for one or more base stations and relays this information to the MSC.

When active, a wireless unit receives signals from at least one base station or cell site over a forward link or downlink and transmits signals to at least one cell site or base station over a reverse link or uplink. There are many different schemes for defining wireless links or channels for a cellular communication system. These schemes include, for example, TDMA (time-division multiple access), FDMA (frequency-division multiple access), and CDMA (code-division multiple access) schemes.

In a CDMA scheme, each wireless channel is distinguished by a distinct channelization code (e.g., spreading code, spread spectrum code or Walsh code) that is used to encode different information streams. These information streams may then be modulated at one or more different carrier frequencies for simultaneous transmission. A receiver may recover a particular stream from a received signal using the appropriate Walsh code to decode the received signal.

Each base station using a spread spectrum scheme, such as CDMA, offers a number of Walsh codes, and consequently, a corresponding number of users, within each sector of a cell. In the CDMA 2000 3G-1X, for example, the number of Walsh codes made available by each sector is defined by the radio configuration (RC) employed by the base station. The maximum number of Walsh codes available for an RC3 assignment is 64, while an RC4 assignment, in contrast, supports a maximum of 128 Walsh codes. Under certain conditions, such as when the majority of users are in benign RF environment, the users are concentrated in the area near antenna or majority of the users are stationary, etc., the capacity of CDMA 2000 3G-1X may exceed the Walsh code capability of an RC3 (radio configuration 3) assignment. RC3 limitation is also expected to be exceeded when technologies, such as transmit diversity, an intelligent antenna(s), and/or a selectable mode vocoder(s) are introduced.

The number of Walsh codes made available by the base station takes into consideration the transmit power requirements associated with the selected radio configuration. For example, an RC4 assignment requires a relatively longer spreading code and has a greater transmit power requirement than an RC3 assignment, which is a relatively shorter spreading code. Consequently, a tradeoff exists between the power efficiency of the base station based on the RC configuration employed and the length/number of spreading codes made available within each sector of a cell. For example, an RC4 assignment may degrade capacity by supporting a weaker coding rate than an RC3 assignment.

Presently, the traffic volume associated with the number of users within each sector of a cell is periodically monitored by an operator(s). The operator may determine that increasing or decreasing the number of Walsh codes available by changing the radio configuration (e.g., between RC3 and RC4), given the traffic volume for a particular time period, to improve the efficient utilization of the base station's resources. For example, the operator may deduce that a number of users were dropped within a peak usage period because the Walsh codes made available by the base station was the maximum allowable within the radio configuration. Upon examining the utilization of the base station's power resources during the same peak usage period, the operator may conclude that switching the radio configuration from RC3 to RC4 would increase efficiency. Likewise, the operator may conclude that switching the radio configuration from RC4 to RC3 would be advantageous given the relatively modest traffic volume during a particular time period, to reduce the expenditure of the base station's power resources.

Changing the radio configuration, however, is labor intensive, requiring manual operation action for each sector or the entire cell. Moreover, the frequency in which the radio configuration may be changed depends on how often the traffic volume and the base station's power resources are monitored by an operator. Consequently, the efficiency of the present approach for changing radio configurations is not maximized.

As a result, a method for changing the radio configuration of a base station employing a spread spectrum scheme is needed that may be less labor intensive. It is hard to achieve the optimal mix of radio configurations on each carrier if performed manually. Similarly, there is a demand for a more efficient process for changing the radio configuration.

### SUMMARY OF THE INVENTION

The present invention provides a method of dynamically assigning spread spectrum codes. More particularly, the present invention offers a method for changing the number of spread spectrum (e.g., Walsh) codes available in response to determining availability and/or remaining capacity of the base station's resources. As a consequence of the present method, the need for an operator to modify the number of spread spectrum codes (e.g., Walsh codes) within each sector of a cell by, for example, changing the radio configuration, in response to monitored traffic volume over time intervals is reduced.

In accordance with the present invention, the number of spread spectrum (e.g., Walsh) codes in use by the base station is compared with a threshold number of spread spectrum codes. If the number of spread spectrum codes being used is less than the threshold number of spread spectrum codes, the base station is configured to offer the fewest number of spread spectrum codes by, for example, assigning a radio configuration, such as RC3. Alternatively, if the number of spread spectrum codes used by the base station exceeds this threshold number, then the usage of base station's resources is evaluated.

Thereafter, in another embodiment, the power used by base station is compared with a power efficiency threshold value. Here, if the power in use by the base station exceeds the power efficiency threshold value, then the base station is configured to offer the fewest number of spread spectrum codes, by, for example, assigning a radio configuration, such as is RC3. However, if the power used by base station is less than the power efficiency threshold value, then the base station is configured to offer an increased number of spread spectrum codes by, for example, assigning a hybrid radio configuration, between RC3 and RC4.

In yet another embodiment, once the number of spread spectrum 20 codes in use is compared with the threshold value, a ratio of the percentage of spread spectrum codes usage to the percentage of power usage is then compared with a resource threshold value. If the ratio exceeds this resource threshold value, then the base station is configured to offer the fewest number of spread spectrum codes, by, for example, assigning a radio configuration, such as RC3. However, if the ratio is less than the resource threshold value, the base station is configured to offer an increased number of spread spectrum codes by, for example, assigning a hybrid radio configuration, between RC3 and RC4.

These and other embodiments will become apparent to those skilled in the art from the following detailed description read in conjunction with the appended claims and the drawings attached hereto.

### BRIEF DESCRIPTION OF THE DRAWINGS

The present invention will be better understood from reading the following description of non-limiting embodiments, with reference to the attached drawings, wherein below:

FIG. 1 depicts a flow chart of an embodiment of the present invention;

FIG. 2 depicts a flow chart of another embodiment of the present invention; and

FIG. 3 depicts a flow chart of yet another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention provides a method of dynamically assigning spread spectrum codes to at least one sector of a cell. The method takes in consideration the available resources, as well as the resources in use by the base station. The method of the present invention determines whether these resources are efficiently being used by the base station, and in response to determining traffic volume, may change the number of spread spectrum codes available. In example of the present invention, the method may change the radio configuration of the base station depending on the usage of the base station resources. For the purposes of the present invention, reference to a base station resources includes, for example, power utilization, power capacity, the number of spread spectrum code in use, as well as the number of spread spectrum code available, as supported by the system.

In CDMA 2000 systems, for example, spreading codes (e.g., Walsh codes) are used for forward channelization. An RC3 assignment supports a maximum of 64 spreading codes, while an RC4 assignment supports a maximum of 128 spreading codes. Consequently, any RC3-based spreading code may produce two (2) RC4-based spreading codes, which can coexist on the same carrier with RC3-based spreading codes. RC3-based spreading codes, however, are more efficient than RC4-based spreading codes because of the power in transmitting each code. Consequently, wireless communication systems may perform a tradeoff analysis between the transmit power requirements of assigning a radio configuration and the availability of channelization codes. It may, therefore, be ideal to maximize the usage of RC3-based spreading codes until traffic volume causes blocking (e.g., dropped calls or inability to access network) to occur.

The present invention teaches using spreading codes (e.g., Walsh codes) of differing lengths, in certain circumstances, to increase the overall capacity of the system. More particularly, the present invention discloses a method for mixing RC3-based and RC4-based spreading codes as the system capacity reaches a maximum, to avoid blocking. By this arrangement, the present method enables a maximum number of calls assigned to RC3, while avoiding spreading codes blocking by starting an RC4 assignment only when necessary.

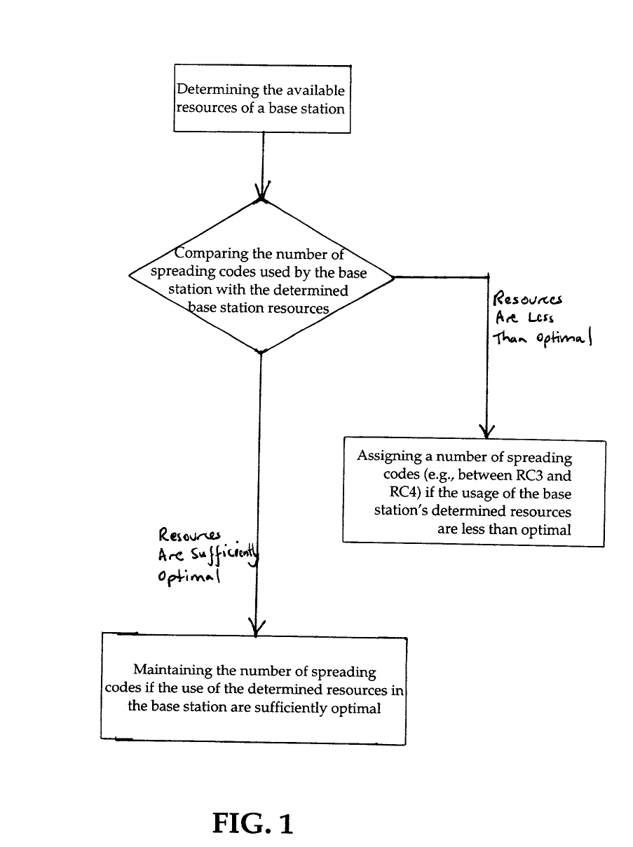

Referring to FIG. 1, a flow chart depicting one embodiment of the present invention is illustrated. More particularly, one approach for a method (10) of assigning a number of spreading codes and/or a radio configuration is depicted. Initially, the available resources of a base station are determined (20). For the purposes of the present disclosure, base station resources may include the number of spreading codes supported by the system, the power available, and the power in use, for example, which may be ascertained during and/or after a call setup routine is initiated.

Thereafter, the number of spreading codes in use by the base station is compared (30) with the determined base stations resources. In performing this step, the method determines the remaining capacity of the system, and costs for adding each new spreading code. If it is determined that the base stations resources are being in a sufficiently optimal manner, then the number of spreading codes available remains the same (40), irrespective of any blocking that may arise.

In the alternative, if it is determined that the base station's resources are being used in a less than optimal manner, then more spreading codes may be added (50) to avoid blocking. This step may be realized by any number of techniques that will be apparent to skilled artisans upon reviewing the instant disclosure. For example, the base station may be assigned a mix of RC3-based and RC4-based spreading codes as a result of determining that the base station's resources are less than optimized.

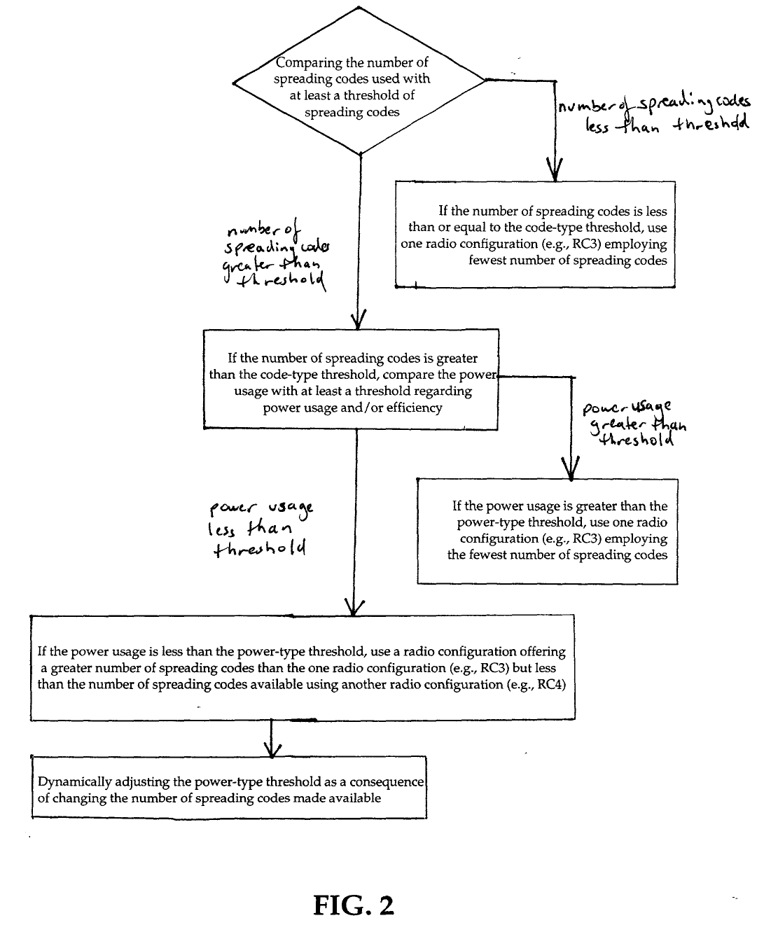

Referring to FIG. 2, a flow chart depicting another embodiment of the present invention is illustrated. Here, another method (100) is shown for assigning a number of spreading codes and/or a radio configuration. The method (100) initially involves comparing the number of spreading codes in use by the base station with a spreading code utilization threshold (110) during and/or after a call setup routine.

If, upon performing the comparing step (110), it is determined that the number of spreading codes in use is less than or equal to the spreading code utilization threshold, then the number of spreading codes available to the base station remains the same (120). By this arrangement, the fewest number of spreading codes may be made available to the base station—e.g., the base station may be configured for an RC3 assignment.

Alternatively, if it is determined that the number of spreading codes in use is less than the spreading code utilization threshold, then the method examines the resources of the base station. More particularly, the transmit power requirements associated with the assigned number of used spreading codes are compared with a power-type threshold corresponding with the power usage and/or efficiency of the base station (130). If it is determined that the transmit power is greater than the power-type threshold, then the number of spreading codes assigned to the base station remains the same (140). By this arrangement, the fewest number of spreading codes, may be made available to the base station—e.g., the base station may be configured for an RC3 assignment.

However, if the transmit power is less than or equal to the power-type threshold, then more spreading codes may be added (150) to avoid blocking. This step may be realized by any number of techniques that will be apparent to skilled artisans upon reviewing the instant disclosure. For example, the base station may be assigned a mix of RC3-based and RC4-based spreading codes as a result of determining that the base stations resources are less than the power-type threshold.

Thereafter, upon changing the number of spreading codes assigned, the method may also include the step of dynamically adjusting the power-type threshold (160). By increasing (or decreasing) the number of available spreading codes, the transmit power requirements associated may likely change. Consequently, to compensate for the newly assigned number of spreading codes, the power-type threshold may be correspondingly adjusted upwardly or downwardly in a dynamic manner. This step may be continuously employed until a steady state is achieved.

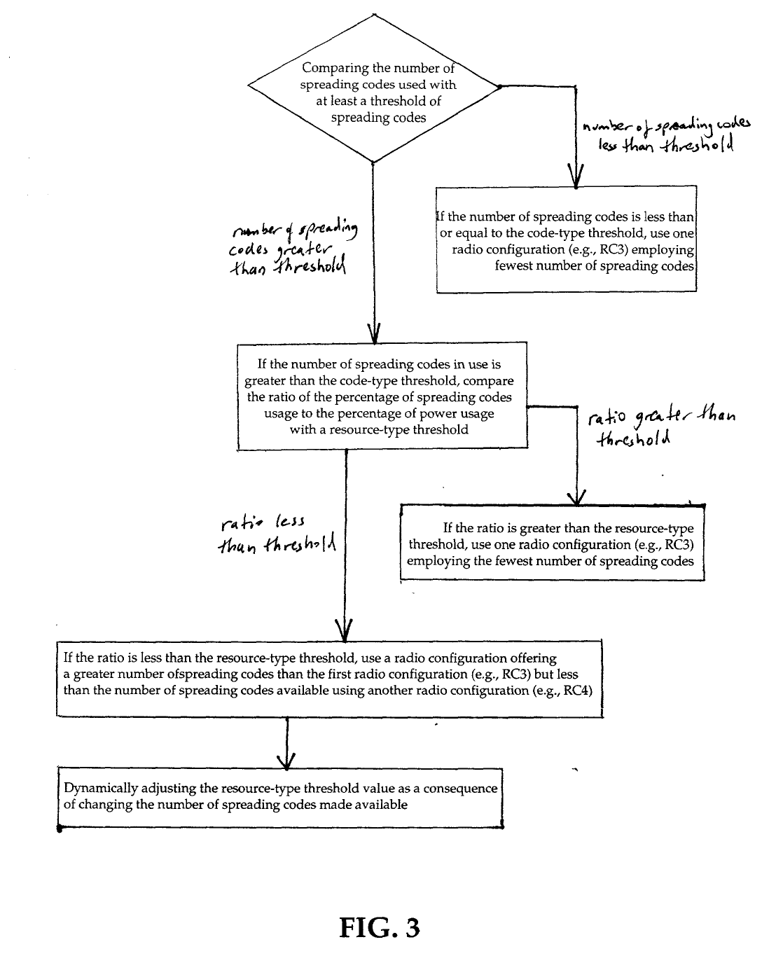

Referring to FIG. 3, a flow chart depicting yet another embodiment of the present invention is illustrated. Here, another method (200) is shown for assigning a number of spreading codes and/or a radio configuration. The method (200) initially involves comparing the number of spreading codes in use by the base station with a spreading code utilization threshold (210) during and/or after a call setup routine.

If, upon performing the comparing step (210), it is determined that the number of spreading codes in use is less than or equal to the spreading code utilization threshold, then the number of spreading codes assigned to the base station remains the same (220). By this arrangement, the fewest number of spreading codes may be made available to the base station—e.g., the base station may be configured for an RC3 assignment.

Alternatively, if it is determined that the number of spreading codes in use is less than the spreading code utilization threshold, then the method performs a calculation based on the resources of the base station. More particularly, the method calculates the percentage of spreading codes usage and the percentage of power usage. For the purposes of the present invention, the percentage of spreading codes usage may be defined as the ratio of the number of spreading codes in use to the number of spreading codes available, while the percentage of power usage may be defined as the ratio of the power used to the power available.

Upon calculating the percentage of spreading codes usage and the percentage of power usage, the method then calculates a final ratio, defined by the percentage of spreading codes usage divided by the percentage of power usage. This calculated final ratio is thereafter compared with a resource-type threshold (230). If, upon performing this comparing step, it is determined that the final ratio is greater than the resource-type threshold, then the number of spreading codes assigned to the base station remains the same (240). By this arrangement, the fewest number of spreading codes, may be made available to the base station—e.g., the base station may be configured for an RC3 assignment.

However, if the final ratio is less than or equal to the resource-type threshold, then more spreading codes may be added (250) to avoid blocking. This step may be realized by any number of techniques that will be apparent to skilled artisans upon reviewing the instant disclosure. For example, the base station may be assigned a mix of RC3-based and RC4-based spreading codes as a result of determining that the comparing step (240).

Thereafter, upon changing the number of spreading codes assigned, the method may also include the step of dynamically adjusting the resource-type threshold (260). By increasing (or decreasing) the number of available spreading codes, the transmissive power requirements associated thereby, and consequently the final ratio, may likely change. Consequently, to compensate for the newly assigned number of spreading codes, the resource-type threshold may be correspondingly adjusted upwardly or downwardly in a dynamic manner. This step may be continuously employed until a steady state is achieved.

It should be noted that users might be segmented or prioritized into classes. For example, a variety of users may require access to fundamental channel, others might require access the supplemental channel, and some might require access to both fundamental and supplemental channels. In this scenario, it is possible to run the embodiments of the present invention for higher priority channels, taking the Walsh code and power ratios into account based on the resources used by these channels. In so doing, the blocking of these channels may be prevented. The lower priority channels, here, may be left on either RC3 or RC4, depending on the limiting resource. Alternatively, lower priority channels may follow the high priority channels.

It should also be noted that while embodiments detailed herein address assigning a number of spreading codes, such as Walsh code by a base station, the present invention is also applicable to quasi-orthogonal Walsh functions, as well as modified Walsh codes and UMTS orthogonal variable spreading factor codes (OVSF).

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method comprising:
assigning a number of spreading codes by a base station in response to determining the base station's available resources.

2. The method of claim 1, wherein the step of assigning a number of spreading codes comprises:
comparing the determined base station's available resources with a number of used spreading codes; and
assigning a first number of spreading codes to the base station if the number of used spreading codes is determined to be less than an optimal resource level.

3. The method of claim 2, wherein the first number is greater than or equal to the minimum number of spreading codes.

4. The method of claim 3, wherein the step of assigning a number of spreading codes further comprises:
assigning a second number of spreading codes if the number of used spreading codes is determined to be equal to the optimal resource level.

5. The method of claim 4, wherein the second number is between the first number and a maximum number of spreading codes.

6. The method of claim 5, wherein the step of assigning a number of spreading codes further comprises:
dynamically adjusting the optimal resource level in response to assigning the second number of spreading codes.

7. The method of claim 1, wherein the step of assigning a number of spreading codes comprises:
comparing the number of used spreading codes with a first threshold; and
assigning a first number of the spreading codes if the number of used spreading codes is less than or equal to the first threshold.

8. The method of claim 7, wherein the first number is a minimum number of spreading codes.

9. The method of claim 8, wherein the step of assigning a number of spreading codes further comprises:
comparing a power employed by the base station with a second threshold if the number of used spreading codes is greater than the first threshold; and
assigning a second number of spreading codes to the base station if the power employed is less than the second threshold.

10. The method of claim 9, wherein the step of assigning a number of spreading codes further comprises:
dynamically adjusting the second threshold in response to assigning the second number of spreading codes.

11. The method of claim 9, wherein the second number is between the first number and a maximum number of spreading codes.

12. The method of claim 7, wherein the step of assigning a number of spreading codes further comprises:
comparing a ratio of a spreading code usage to a power usage with a second threshold if the number of used spreading codes is greater than the first threshold;
assigning a second number of spreading codes to the base station if the ratio employed is less than the second threshold.

13. The method of claim 12, wherein the step of assigning a number of spreading codes further comprises:
dynamically adjusting the second threshold in response to assigning the second number of spreading codes.

14. The method of claim 12, wherein the second number is between the first number and a maximum number of spreading codes.

15. A method for assigning a number of spreading codes by a base station, the method comprising the steps of:
comparing a number of spreading codes in use by the base station with a first threshold;
assigning one radio configuration if the number of spreading codes in use is less than or equal to the first threshold;
comparing a power level employed by the base station with a second threshold if the number of used spreading codes is greater than the first threshold; and
assigning another radio configuration if the power level employed is less than the second threshold.

16. The method of claim 15, wherein the one radio configuration supports a first number of spreading codes, and the another radio configuration supports a second number of spreading codes, the second number of spreading codes between the first number and a maximum number of spreading codes.

17. The method of claim 16, wherein the step of assigning another radio configuration comprises:
dynamically adjusting the second threshold in response to supporting the second number of spreading codes.

18. A method for assigning a number of spreading codes by a base station, the method comprising the steps of:
comparing a number of spreading codes in use by the base station with a first threshold;
assigning a first radio configuration if the number of spreading codes in use is less than or equal to the first threshold;
comparing a ratio of a spreading code usage to a power usage with a second threshold if the number of spreading codes in use is greater than the first threshold; and
assigning another radio configuration if the ratio is less than the second threshold.

19. The method of claim 18, wherein the one radio configuration supports a first number of spreading codes, and the another radio configuration supports a second number of spreading codes, the second number of spreading codes between the first number and a maximum number of spreading codes.

20. The method of claim 19, wherein the step of assigning another radio configuration comprises:
dynamically adjusting the second threshold in response to supporting the second number of spreading codes.
